(19) United States
(12) Patent Application Publication
(10) Pub. No.: US 2024/0216894 A1
(43) Pub. Date: Jul. 4, 2024

(54) COMPOSITE CATALYST FOR CARBON DIOXIDE ABSORBENT REGENERATION

(71) Applicant: KOREA INSTITUTE OF ENERGY RESEARCH, Daejeon (KR)

(72) Inventors: Sung Chan NAM, Daejeon (KR); Il Hyun BAEK, Daejeon (KR); Jong Tak JANG, Daejeon (KR)

(73) Assignee: KOREA INSTITUTE OF ENERGY RESEARCH, Daejeon (KR)

(21) Appl. No.: 18/104,926

(22) Filed: Feb. 2, 2023

(30) Foreign Application Priority Data
Dec. 21, 2022 (KR) 10-2022-0180188

(51) Int. Cl. B01J 23/755; B01D 53/14; B01J 21/18; B01J 23/28; B01J 23/745; B01J 35/00; B01J 35/10; B01J 37/02; B01J 37/08

(52) U.S. Cl. CPC B01J 23/755; B01D 53/1425; B01D 53/1475; B01D 53/1493; B01J 21/18; B01J 23/28; B01J 23/745; B01J 35/0066; B01J 35/1019; B01J 35/1023; B01J 35/1042; B01J 37/0213; B01J 37/0215; B01J 37/0236; B01J 37/088; B01D 2252/20405; B01D 2252/20421; B01D 2252/20484; B01D 2252/602

(57) ABSTRACT

The present invention provides a composite catalyst for diminishing energy demand during carbon dioxide absorbent regeneration and a method for producing the same.

The present invention more particularly relates to a composite catalyst in which the surface or inside of activated carbon activated carbon used as a porous carrier is modified with oxides of one or more metals selected from a transition metal group consisting of Fe, Ni, and Mo, and a method for producing the composite catalyst.

The activated carbon composite catalyst modified with a metal of the present invention is able to regenerate MEA (monoethanolamine) at a low temperature of 100° C. or below to diminish heat consumption, can decrease the heat duty by increasing the carbon dioxide desorption rate at a low temperature of 100° C. or below as well as acquire improved results through the relation between the BET surface area and the total acid sites, and can be usefully used as a technology capable of diminishing energy demand during energy-efficient CO₂ absorbent regeneration at an economical cost since materials for production are inexpensive and abundant.

### BACKGROUND OF THE INVENTION

### Field of the Invention

The present invention relates to a composite catalyst for diminishing energy demand during carbon dioxide absorbent regeneration and a method for producing the same, more particularly relates to a composite catalyst in which the surface or inside of activated carbon used as a porous carrier is modified with oxides of one or more metals selected from a transition metal group consisting of Fe, Ni, and Mo, and a method for producing the composite catalyst.

### Description of the Related Art

Carbon dioxide (CO₂) gas is considered as the most influential contributor to climate change. Therefore, carbon dioxide capture technologies to minimize carbon dioxide emission may include, for example, membrane separation, adsorption processes, chemical roofing combustion, and chemical absorption. However, chemical absorption is the most advanced technology and may be further classified into three technologies of pre-combustion, oxy-fuel combustion, and post-combustion carbon dioxide capture.

Post-combustion carbon dioxide separation is the most feasible technology for technology maturity and retrofitting to current power plants. However, because of the low desorption capacity, CO₂ desorption and MEA regeneration are possible at a high temperature of 100° C. or more in the stripping column, and a huge amount of thermal energy is consumed, accounting for 70% to 80% of the total operating cost. Because of the high specific heat and latent heat capacities of water in an aqueous amine solution, a significant portion of the total consumed heat is spent for heating and vaporizing water.

Alternative solvents, nanoparticles, ionic liquids and solid-acid catalysts are used to compensate for the above-described drawbacks, or attention is being paid to improving the amine regeneration process by improving current methods. Meng's research team has tested six MEA derivatives in the carbon dioxide absorption process to find a better solvent than MEA, and as a result, ethyl monoethanolamine (EMEA) can significantly diminish the heat requirement for carbon dioxide stripping. According to the research results by Alivand et al., 44.7% of energy may be diminished in the carbon capture process through Fe₃O₄—COOH nanoparticles. Ma's research team has conducted a test comparing the MEA process with two ionic liquids, and [bmim][BF₄] and [bmim][PF₆] have diminished the regeneration heat duty by 26.7% and 24.8%, respectively. Although these alternative solvents show improved performance, the annual production of the solvents alone is not sufficient to meet the demand, and the solvents show slower reaction kinetics compared to currently commercially available monoethanolamine (MEA).

Currently, the technology of adding a catalyst is mainly used to promote carbamate decomposition by donating protons. Bhatti's research team has studied various metal oxides and found that V₂O₅ and MoO₃ rapidly regenerate the solvent by desorbing 94% and 84% of additional carbon dioxide by volume, respectively, compared to the system using MEA only. In addition, Ag₂O and Nb₂O₅ also showed useful results of desorbing carbon dioxide by 36% and 35%, respectively, compared to the system using MEA only. Bhatti's research team has also been able to increase the carbon dioxide stripping rate by 580% through washing with porous HZSM-5 and an alkali salt (NaOH) and the catalyst thereof, and able to diminish the heat of desorption by 37% at a low temperature of 82° C. or below because of the presence of Bronsted and Lewis acid sites. In the most recent studies, Sun's research team has tested the effect of nickel (Ni) content on HZSM-5 activity, and acquired results that the power load of reboiler decreases to 27%. Lai's research team has been able to remarkably increase the rate of carbon dioxide separation from ethanolamine by 4500% or more when TiO(OH)₂ catalyst is applied, and the catalyst was stable up to 50 cycles. Similarly, Bhatti's research team has discovered a clay called montmorillonite and activated the clay with several acids and metals to impart mesoporous properties and acidity, and been able to shift the regeneration temperature of the amine solvent to a lower temperature (approx. 86° C.) through the Bronsted acid site. However, as such strategy is still in its infancy, only a limited range of catalysts have been introduced, a large number of which is expensive, and it is thus required to develop inexpensive and quantitatively abundant catalysts.

Activated carbon can be chemically modified because of its larger surface area, and for metal insertion, the chemical adsorption performance of activated carbon may improve catalytic and adsorption processes. Therefore, acidity may be imparted to activated carbon through a metal activation method. Activated carbon modified with metals (Ni, Mo, and Fe) may be produced through the methods, and this enables CO₂ desorption at a low temperature (86° C.) and low thermal energy consumption for amine regeneration. Hence, it is significantly important to use a metal-modified composite catalyst obtained using activated carbon.

### SUMMARY OF THE INVENTION

Accordingly, the technical object to be achieved by the present invention is to provide an activated carbon composite catalyst modified with a metal material of Fe, Ni or Mo for diminishing energy demand during carbon dioxide absorbent regeneration and a method for producing the same.

However, the technical object to be achieved by the present invention is not limited to the above-mentioned technical object, and other technical objects not mentioned will be clearly understood by those skilled in the art to which the present invention pertains from the description below.

In order to achieve the technical object, an aspect of the present invention provides
a composite catalyst for carbon dioxide absorbent regeneration containing a porous carrier; a metal material supported on a surface or inside of the porous carrier; and an acid site that donates a proton (H⁺) to decompose a carbamate derived from an amine-based carbon dioxide absorbent, in which the metal material is a metal element, a metal oxide, or a combination thereof.

The metal material may be elements or oxides of one or more metals selected from a transition metal group consisting of Fe, Ni and Mo or a combination thereof.

The BET surface area of the composite catalyst for carbon dioxide absorbent regeneration may be 400 to 600 m²/g.

The pore volume of the composite catalyst for carbon dioxide absorbent regeneration may be less than 0.7 cm³/g.

The metal content in the composite catalyst for carbon dioxide absorbent regeneration may be 5 to 12 wt %.

The acidity (total acid sites; TAS) of the composite catalyst for carbon dioxide absorbent regeneration may be 2.5 to 6.5 mmol/g.

In the NH₃-temperature programming desorption acidity curve of the composite catalyst for carbon dioxide absorbent regeneration, the peak intensity of a strong acid site assigned to a temperature range of more than 400° C. may be larger than the peak intensity of the pure porous carrier by 1.3 to 4 times.

The carbon dioxide desorption capacity of the composite catalyst for carbon dioxide absorbent regeneration expressed by the following Formula 1 may be 1500 to 3000 mmol·m²/g².

$$( BET surface area ( {m}^{2} / g ) ) \times ( total acid sites ( mmol / g ) ) of composite catalyst \qquad [ Formula 1 ]$$

The amount of carbon dioxide desorbed by the composite catalyst for carbon dioxide absorbent regeneration may be 69 to 73 mmol.

The heat duty of the composite catalyst for carbon dioxide absorbent regeneration may be 77% to 83% of the heat duty in the desorption reaction not involving the catalyst.

The porous carrier may be activated carbon.

Another aspect of the present invention provides
a method for producing a composite catalyst for carbon dioxide absorbent regeneration, the method including dissolving a precursor of a metal material in a solvent to prepare a mixture; injecting the mixture into a surface or inside of a porous carrier to prepare a support solution; drying the support solution; and performing calcination to obtain a composite catalyst, in which the composite catalyst contains an acid site that donates a proton (H⁺) to decompose a carbamate derived from an amine-based carbon dioxide absorbent, and the metal material is a metal element, a metal oxide, or a combination thereof.

In the step of dissolving a precursor of a metal material in a solvent to prepare a mixture, the mass percentage of the metal material precursor may be 8 to 12 wt % based on the total weight of the mixture.

The step of drying the support solution may be performed at a temperature of 80° C. to 120° C. for 5 to 7 hours.

The step of performing calcination to obtain a composite catalyst may be performed in a temperature range of 450° C. to 550° C. for 5 to 7 hours.

### BRIEF DESCRIPTION OF THE DRAWINGS

The patent or application file contains at least one color drawing. Copies of this patent or patent application publication with the color drawing(s) will be provided by the USPTO upon request and payment of the necessary fee.

FIG. 1 illustrates relation between the total amount of CO₂ desorbed and the BET surface area, the acidity and the product thereof in order to explore the effect of catalyst properties on CO₂ desorption according to an embodiment of the present invention;

FIG. 2 illustrates the schematic summary of a method for producing a catalyst according to an embodiment of the present invention;

FIG. 3 illustrates the schematic diagram of a CO₂ desorption apparatus according to an embodiment of the present invention;

FIG. 4A illustrates XRD patterns recorded for AC, Fe/AC, Ni/AC and Mo/AC according to an embodiment of the present invention; FIG. 4B illustrates the N₂ adsorption-desorption isotherms of AC and metal-impregnated AC according to an embodiment of the present invention, and FIG. 4C illustrates the ammonia desorption curves for a parent and a produced metal-impregnated activated carbon (AC) catalyst according to an embodiment of the present invention;

FIG. 5 illustrates scanning electron microscope (SEM) images of a parent and a molybdenum-impregnated activated carbon catalyst together with energy dispersive X-ray spectroscopy (EDS) mapping of Mo/AC according to an embodiment of the present invention;

FIG. 6 illustrates scanning electron microscope (SEM) images of a parent and an iron (Fe)-impregnated activated carbon catalyst together with energy dispersive X-ray spectroscopy (EDS) mapping of Fe/AC according to an embodiment of the present invention;

FIG. 7 illustrates scanning electron microscope (SEM) images of a parent and a nickel (Ni)-impregnated activated carbon catalyst together with energy dispersive X-ray spectroscopy (EDS) mapping of Ni/AC according to an embodiment of the present invention;

FIG. 8 is a graph illustrating the results of a MEA-CO₂ absorption experiment according to an embodiment of the present invention;

FIG. 9A illustrates the configuration of CO₂ desorption rates in cases of using no catalyst, 5 g of AC, and M/AC according to an embodiment of the present invention, FIG. 9B illustrates the amount of CO₂ desorbed in the ramp-up stage and the entire experiment according to an embodiment of the present invention, and FIG. 9C illustrates the relative heat duty of catalyst-amine solutions to the heat duty in a blank MEA test according to an embodiment of the present invention; and

FIG. 10 illustrates a possible mechanism for MEA regeneration by carbamate decomposition and CO₂ release according to an embodiment of the present invention.

### DETAILED DESCRIPTION OF THE PREFERRED EMBODIMENTS

Hereinafter, the present invention will be described in more detail with reference to the accompanying drawings. However, the present invention may be implemented in many different forms and, therefore, is not limited to the embodiments described herein. In order to clearly explain the present invention in the drawings, parts irrelevant to the description are omitted, and similar reference numerals have been assigned to similar parts throughout the specification.

Throughout the specification, when a part is said to be “connected (linked, in contact, coupled)” with another part, this includes not only the case of being “directly connected” with another member but also the case of being “indirectly connected” with another member interposed therebetween. In addition, when a part “includes” a certain component, this means that the part does not exclude other components but may further include other components unless otherwise stated.

Terms used in this specification are only used to describe specific embodiments, and are not intended to limit the present invention. Singular expressions include plural expressions unless the context clearly dictates otherwise. In this specification, it should be understood that terms such as “include” or “have” are intended to designate the presence of features, numbers, steps, operations, components, parts, or combinations thereof described in the specification but not to preclude the presence or addition of one or more other features, numbers, steps, operations, components, parts, or combinations thereof.

In describing the present invention, if it is determined that a detailed description of a related known configuration or function may obscure the gist of the present invention, the detailed description may be omitted.

A first aspect of the present application provides
a composite catalyst for carbon dioxide absorbent regeneration containing a porous carrier; a metal material supported on a surface or inside of the porous carrier; and an acid site that donates a proton (H⁺) to decompose a carbamate derived from an amine-based carbon dioxide absorbent, in which the metal material is a metal element, a metal oxide, or a combination thereof.

Hereinafter, the composite catalyst for carbon dioxide absorbent regeneration according to the first aspect of the present application will be described.

In an embodiment of the present application, the metal material may be elements or oxides of one or more metals selected from a transition metal group consisting of Fe, Ni and Mo or a combination thereof, and the purpose of the ultimately produced catalyst may be a composite catalyst for carbon dioxide absorbent regeneration.

In an embodiment of the present application, the catalyst may be characterized as a composite catalyst by being tested through XRD (X-ray powder diffraction), NH₃-TPD (ammonia temperature programmed desorption), nitrogen adsorption and desorption, SEM (scanning electron microscopy), EDS (energy dispersive X-ray spectroscopy) and ICP-OES (inductively coupled plasma—optical emission spectrometry).

In an embodiment of the present application, the composite catalyst for carbon dioxide absorbent regeneration may be characterized through BET measurement. In an embodiment of the present application, the BET surface area of the composite catalyst for carbon dioxide absorbent regeneration may be 300 m²/g or more, 320 m²/g or more, 350 m²/g or more, 375 m²/g or more, 400 m²/g or more, or 425 m²/g or more and 700 m²/g or less, 675 m²/g or less, 650 m²/g or less, 625 m²/g or less, 600 m²/g or less, or 575 m²/g or less, and may preferably be 400 to 600 m²/g. In a case where the BET surface area is less than the above range, regeneration of the amine-based carbon dioxide absorbent may not be sufficiently performed. In a case where the BET surface area exceeds the above range, the surface area may unnecessarily increase in comparison with the improvement in regeneration performance.

In an embodiment of the present application, the composite catalyst for carbon dioxide absorbent regeneration may be characterized through the measurement of pore volume. In an embodiment of the present application, the pore volume of the composite catalyst for carbon dioxide absorbent regeneration may be less than or equal to 0.3 cm³/g, less than or equal to 0.45 cm³/g, or less than or equal to 0.6 cm³/g, and preferably less than 0.7 cm³/g. In a case where the pore volume is less than the above range, a too large volume of nitrogen gas may be adsorbed to lower the activity of catalyst. In a case where the pore volume exceeds the above range, the modification with a metal may not be performed smoothly and this may affect the metal content.

In an embodiment of the present application, the composite catalyst for carbon dioxide absorbent regeneration may be characterized through the measurement of metal content. In an embodiment of the present application, the metal may not be detected in a case where the composite catalyst for carbon dioxide absorbent regeneration is not modified with a metal, and the metal content in the composite catalyst for carbon dioxide absorbent regeneration may be 5 to 15 wt %, more preferably 8 to 12% in a case where the composite catalyst is modified with a metal. In a case where the metal content is less than the above range, the modification with a metal may not be performed smoothly and the characteristics of a metal-modified composite catalyst for carbon dioxide absorbent regeneration may not be exhibited. In a case where the metal content exceeds the above range, modification with an unnecessarily large amount of metal may be performed and this may affect the pore volume.

In an embodiment of the present application, the acidity (total acid sites; TAS) of the composite catalyst for carbon dioxide absorbent regeneration may be 2.0 mmol/g or more or 2.9 mmol/g or more and 4.5 mmol/g or less or 6.9 mmol/g or less, and may preferably be 2.5 to 6.5 mmol/g. In a case where the acidity is less than the above range, protons may not be donated to stable carbamate molecules, and carbon dioxide may not be desorbed sufficiently. In a case where the acidity exceeds the above range, a large amount of heat duty may be generated in production of the composite catalyst.

In an embodiment of the present application, in the NH₃-temperature programming desorption acidity curve of the composite catalyst for carbon dioxide absorbent regeneration, the peak intensity of a strong acid site assigned to a temperature range of more than 400° C. may be larger than the peak intensity of the pure porous carrier by 1.2 to 3 times, more preferably 1.3 to 4 times. In a case where the peak intensity is less than the above range, the acidity may decrease. In a case where the peak intensity is equal to or more than the above range, the acidity may increase.

In an embodiment of the present application, the carbon dioxide desorption capacity of the composite catalyst for carbon dioxide absorbent regeneration expressed by the following Formula 1 may be 1200 mmol·m²/g² or more or 1350 mmol·m²/g² or more and 3500 mmol·m²/g² or less or 2750 mmol·m²/g² or less, and may more preferably be 500 to 3000 mmol·m²/g². In a case where the carbon dioxide desorption capacity is less than the above range, the characteristics of a metal-modified composite catalyst for carbon dioxide absorbent regeneration may not be exhibited. In a case where the carbon dioxide desorption capacity exceeds the above range, unnecessary expansion of BET area or unnecessarily high acidity may be required to enhance the desorption capacity.

$$( BET surface area ( {m}^{2} / g ) ) \times ( total acid sites ( mmol / g ) ) of composite catalyst \qquad [ Formula 1 ]$$

In an embodiment of the present application, the amount of carbon dioxide desorbed by the composite catalyst for carbon dioxide absorbent regeneration may be 57 mmol or more, 63 mmol or more and 80 mmol or less, 70 mmol or less, and may preferably be 69 to 73 mmol. In a case where the amount of carbon dioxide desorbed is less than the above range, the carbon dioxide desorption characteristics using the catalyst may not be exhibited. In a case where the amount of carbon dioxide desorbed is equal to or more than the above range, excessive heat duty may be required.

In an embodiment of the present application, the heat duty of the composite catalyst for carbon dioxide absorbent regeneration may be 70% or more or 75% or more and 90% or less or 86% or less of the heat duty in the desorption reaction not involving the catalyst, and may more preferably be 77% to 83%. In a case where the heat duty is less than the above range, high thermal energy may be consumed for catalyst production. In a case where the heat duty is equal to or more than the above range, the energy consumption diminishing effect may not be improved.

In an embodiment of the present application, the porous carrier may include, but is not limited to, modified activated carbon, unmodified activated carbon, montmorillonite (Mont), zeolite, and silica, and may most preferably be activated carbon.

A second aspect of the present application provides
a method for producing a composite catalyst for carbon dioxide absorbent regeneration, the method including dissolving a precursor of a metal material in a solvent to prepare a mixture; injecting the mixture into a surface or inside of a porous carrier to prepare a support solution; drying the support solution; and performing calcination to obtain a composite catalyst, in which the composite catalyst contains an acid site that donates a proton (H⁺) to decompose a carbamate derived from an amine-based carbon dioxide absorbent, and the metal material is a metal element, a metal oxide, or a combination thereof.

Although detailed descriptions of parts overlapping with the first aspect of the present application have been omitted, the contents described for the first aspect of the present application can be equally applied even if the description is omitted in the second aspect.

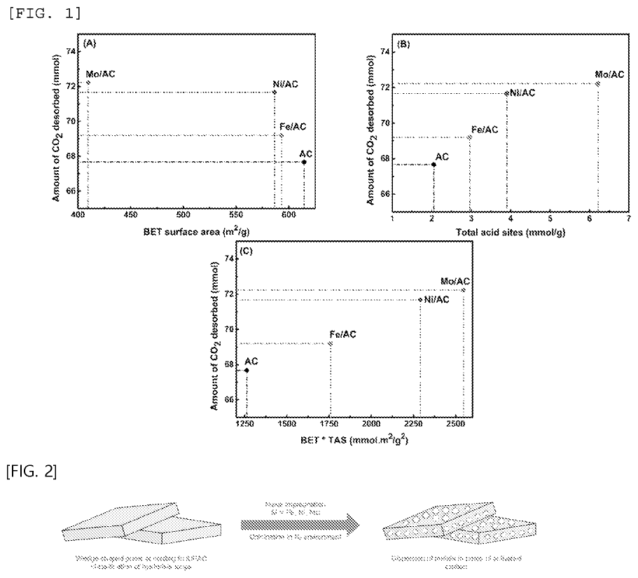

Hereinafter, the method for producing a composite catalyst for carbon dioxide absorbent regeneration according to the second aspect of the present application will be described in detail. FIG. 2 illustrates the schematic summary of a method for producing a catalyst according to an embodiment of the present invention. In an embodiment of the present application, incipient wetness impregnation may be adopted and used for synthesis.

First, in an embodiment of the present application, the method for producing a composite catalyst for carbon dioxide absorbent regeneration may include a step of dissolving a precursor of a metal material in a solvent to prepare a mixture.

In an embodiment of the present application, in the composite catalyst for carbon dioxide absorbent regeneration in which the metal material is elements or oxides of one or more metals selected from a transition metal group consisting of Fe, Ni and Mo or a combination thereof, an activated carbon (AC) catalyst may be selected as the carrier.

In an embodiment of the present application, in the step of dissolving a precursor of a metal material in a solvent to prepare a mixture, the mass percentage of the metal material precursor may be 6 to 15 wt %, more preferably 8 to 12 wt % based on the total weight of the mixture. In a case where the mass percentage of the metal material precursor is less than the above range, the modification with a metal may not be sufficiently performed. In a case where the mass percentage of the metal material precursor exceeds the above range, a larger amount of metal precursor than necessary may be used and the metal precursor may be wasted.

In an embodiment of the present application, the method may include a step of injecting the mixture into the surface or inside of a porous carrier to prepare a support solution. In an embodiment of the present application, a homogeneous solution may be obtained by performing stirring at room temperature for 20 to 40 minutes, more preferably for 25 to 35 minutes. The method may include a step of injecting the metal into heavy AC using the resulting homogeneous solution for injecting the mixture into the surface or inside of a porous carrier to prepare a support solution.

Next, in an embodiment of the present application, the method may include a step of drying the support solution.

In an embodiment of the present application, the step of drying the support solution may be performed on the heavy AC sample injected with a metal at a temperature of 60° C. or more or 90° C. or more and 150° C. or less or 110° C. or less, more preferably 80° C. to 120° C. for 4 to 8 hours, more preferably for 5 to 7 hours. In a case where the step of drying the support solution is performed at a temperature lower than the above temperature for a time shorter than the above time, sufficient drying may not be performed. In a case where the step of drying the support solution is performed at a temperature higher than the above temperature for a time longer than the above time, unnecessary energy is consumed, which is inefficient.

Next, in an embodiment of the present application, the method may include a step of performing calcination to obtain a composite catalyst.

In an embodiment of the present application, the step of performing calcination to obtain a composite catalyst may be performed at a temperature of 400° C. or more or 500° C. or more and 600° C. or less or 580° C. or less, more preferably in a temperature range of 450° C. to 550° C. for 4 to 8 hours, more preferably for 5 to 7 hours. In a case where the step of performing calcination to obtain a composite catalyst is performed at a temperature lower than the above temperature for a time shorter than the above time, sufficient calcination may not be performed. In a case where the step of performing calcination to obtain a composite catalyst is performed at a temperature higher than the above temperature for a time longer than the above time, unnecessary energy is consumed, which is inefficient.

In an embodiment of the present application, the method may include a step of calcining the dried support solution to obtain a composite catalyst, which is performed in an N₂ environment within the above-described temperature and time ranges.

In an embodiment of the present application, a method for producing a composite catalyst for carbon dioxide absorbent regeneration may be provided in which the composite catalyst contains an acid site that donates a proton (H⁺) to decompose a carbamate derived from an amine-based carbon dioxide absorbent, and the metal material is a metal element, a metal oxide, or a combination thereof. The composite catalyst for carbon dioxide absorbent regeneration produced through the method described above may be named Ni/AC, Fe/AC, and Mo/AC.

In an embodiment of the present application, the catalytic performance of activated carbon and the modified activated carbon catalyst may be measured through the carbon dioxide desorption rate, the total amount of carbon dioxide desorbed, and the relative heat duty during MEA regeneration. The physicochemical and acidic properties of the produced activated carbon and metal-modified activated carbon catalyst may be identified through XRD, BET, ICP-OES, NH₃-TPD and SEM-EDS analysis techniques, and the catalytic performance may be identified through the results of a single property or a combination of properties.

In an embodiment of the present application, experimental results may be acquired for all catalysts, including activated carbon, which is the parent material, and the carbon dioxide desorption rate may be increased and the energy consumed for amine regeneration may be diminished. Among others, most preferably, Mo/AC may have the best performance by having a maximum desorption rate of 4.24 mmol/min, may also increase the total amount of carbon dioxide desorbed by 27%, and may exhibit the maximum energy consumption diminishing effect in MEA regeneration by diminishing the energy consumption by 21.2%.

In an embodiment of the present application, the produced activated carbon and metal-modified activated carbon catalyst may acquire improved results through the relation between the BET surface area and the total acid sites, and the catalytic mechanism for the decomposition of carbamates and the deprotonation of amines may be identified through the results. The method may be a method to utilize commonly available and relatively inexpensive activated carbon in the production of excellent catalysts for amine regeneration.

Hereinafter, Examples of the present invention will be described in detail so that those skilled in the art to which the present invention pertains may easily implement the present invention. However, the present invention may be implemented in many different forms and is not limited to Examples described herein.

### Example 1: Absorption Experiment

Monoethanolamine (MEA) was mixed in deionized water at 400 to 600 rpm, more preferably at 450 to 550 rpm for 25 to 35 minutes to prepare 1 L of 5M MEA solution, and the mixture was transferred to a continuous stirred tank reactor (CSTR) equipped with a mechanical impeller (rotor) and continuously mixed. The mixture may include a process of mixing carbon dioxide and nitrogen gas at a volume ratio of 15:85 and introducing the mixed gas into the solution under normal absorption conditions of 40° C. and 1 atm, and the outflowing gas is set by a gas chromatograph, preferably Model 6890A manufactured by Agilent Technologies, and is detected by the gas chromatography.

It may be understood that the MEA mixed solution is in a saturated state when having an almost constant carbon dioxide vol % in gas chromatography, and the loading amount of rich-MEA solution is set by a total organic carbon (TOC) analyzer, more preferably Model multi-N/C 3100 manufactured by Analytik Jena, and is measured by the TOC analyzer at 0.5 mol CO₂/mol MEA to 0.6 mol CO₂/mol MEA, more preferably 0.525 mol CO₂/mol MEA to 0.575 mol CO₂/mol MEA.

### Example 2: CO₂ Catalyst Absorption/MEA Regeneration Experiment

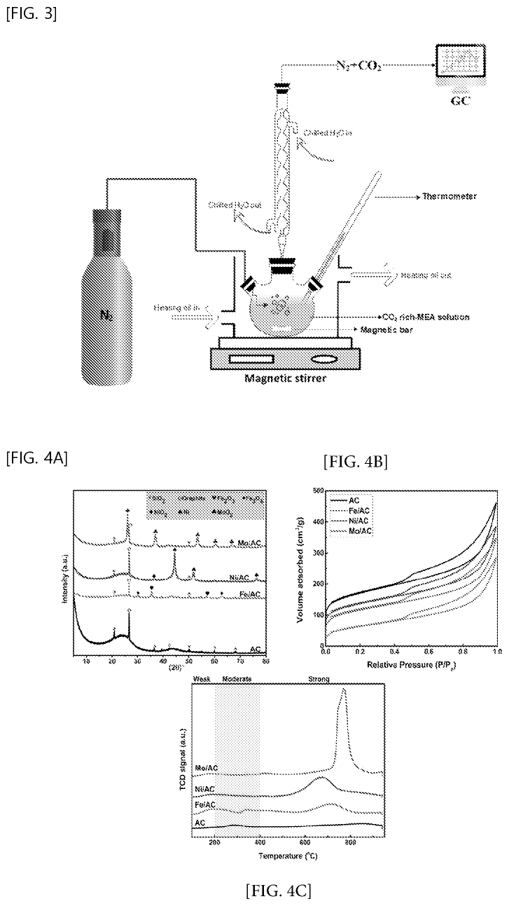

Rich-MEA solution may be used in all tests, and preferably, 100 ml of carbon dioxide rich-MEA solution may be used to observe the desorption of carbon dioxide. Before each test is conducted, the inside of the pipe is washed with nitrogen, and as illustrated in FIG. 3, the carbon dioxide rich-MEA solution is heated in a double glass reactor by an oil heater connected to the same reactor.

Referring to FIG. 3, the reactor is fixed to a three-pronged lid through a stainless steel clamp, and has a structure in which a condenser is connected to the middle lid to suppress evaporation of the amine solution. A thermometer and a nitrogen pipe (1000 cc/min) are inserted into the remaining two lid necks, respectively, to measure the solution temperature and transfer carbon dioxide to the gas chromatograph GC-6890A.

At room temperature (25° C.), 4 g to 6 g of catalyst is added to the MEA solution that has absorbed carbon dioxide, and the experimental data may be acquired at a temperature of 40° C. to 86° C. while the temperature is changed at a rate of 4° C./min, and the temperature may be maintained at 86° C. except when the desorption rate of carbon dioxide falls below 0.1% at the end of this test. A power meter is connected to a heating oil circulator to measure the heat required for MEA regeneration, and the test results acquired without using a catalyst may be used as a comparison group to measure the degree of improvement in all catalyst tests.

### Example 3: Related Equations

After the carbon dioxide desorption experimental data is acquired through gas chromatography, the carbon dioxide desorption rate may be calculated through Equation 1 below. The following Q_{CO2} is the carbon dioxide desorption rate

$$( \frac{mmol}{min} ) ,$$

y_{CO2} is the vol. % of carbon dioxide released (degassed) from the MEA solution, and V_{N}_{₂} denotes the flow rate of nitrogen gas

$$( \frac{mL}{min} ) .$$

$${Q}_{CO 2} = \frac{{V}_{{N}_{2}}}{22.4} \times ⌈ \frac{{y}_{{CO}_{2}}}{( 1 - {y}_{{CO}_{2}} )} ] \qquad [ Equation 1 ]$$

The total amount of carbon dioxide desorbed may be calculated through the integration of Q_{CO2} of Equation 2 below. N_{CO2} denotes the total amount (mmol) of carbon dioxide desorbed, Q_{CO2} is the carbon dioxide desorption rate

$$( \frac{mmol}{min} ) ,$$

and t denotes the time (min) required for the test.

$${N}_{CO 2} = {\int }_{0}^{t} {Q}_{CO 2} dt \qquad [ Equation 2 ]$$

The regeneration heat duty of the MEA solution may be calculated through Equation 3 below, and may be calculated by measuring the amount of power required to heat the oil circulator through a power meter (Wattman HPM-100A). The following HD

$$( \frac{kJ}{mol} )$$

denotes the regeneration heat duty of the MEA solution that has absorbed carbon dioxide, E(kJ) denotes the electrical energy consumed in the process, and N_{CO2} denotes the amount (mol) of carbon dioxide desorbed.

$$HD = \frac{E}{{N}_{CO 2}} \qquad [ Equation 3 ]$$

For more accurate analysis of catalytic performance, it may be desirable to use a relative heat duty value through comparison with the heat duty in the absence of catalyst, as shown in Equation 4 below. The measured values of the heat duty of the MEA solution containing a catalyst and the MEA solution not containing a catalyst are denoted as HD_{catalytic} and HD_{benchmark}, respectively, and RHD (%) denotes the relative heat duty.

$$RHD = \frac{{HD}_{catalystic}}{{HD}_{benchmark}} \times 100 \qquad [ Equation 4 ]$$

Because of the existence of a site exhibiting acidity, it is possible to desorb carbon dioxide at a lower temperature by donating a proton (H⁺) to a stable carbamate (MEACOO⁻) molecule.

### Example 4: Preparing Ethanolamine and Carrier

The prepared ethanolamine having a purity of 99% or higher is preferably purchased from Sigma Aldrich and used, but may be replaced with ethanolamine purchased from other manufacturers for convenience, and it is preferable to use all substances as purchased. All metal precursors, Ni(NO₃)₂·6H₂O (≥98%), Fe(NO₃)₃·9H₂O (≥98%), (NH₄)₆Mo₇O₂₄·4H₂O (81% to 83% MoO₃ basis), and activated carbon (7440-44-0) are also preferably purchased from Sigma Aldrich and used, but may be replaced with metal precursors purchased from other manufacturers for convenience, and it is preferable to use all substances as purchased. For reference, carbon dioxide and nitrogen gases having a purity of 99.999% are preferably purchased from Binggrae Industrial Gas Co., Ltd. and Jungbu Industrial Gas Co., Ltd., respectively, and used, but may be replaced with carbon dioxide and nitrogen gases purchased from other manufacturers for convenience, and it is preferable to use all substances as purchased.

In general, in all cases, the carrier may be prepared by taking a certain mass of activated carbon. The metal-modified precursor contains Ni(NO₃)₂·6H₂O (9898%), Fe(NO₃)₃·9H₂O (9898%), (NH₄)₆Mo₇O₂₄·4H₂O (81% to 83% MoO₃ basis), the mass percentage of the metal-modified precursor is 8 to 12 wt % based on the total weight of the mixture, a more preferable mass percentage is calculated to be 9 to 11 wt %, and each amount is sufficiently dissolved in deionized water to prepare a mixture in which a precursor of a metal material is dissolved in a solvent.

### Experimental Example 1: Physical Properties Evaluation

### 1. XRD (X-Ray Powder Diffraction) Analysis

The existence of each metal may be confirmed through XRD analysis of the metal-modified catalyst, and the XRD patterns measured for AC, Fe/AC, Ni/AC and Mo/AC are illustrated in FIG. 4A.

For AC, carbon (JCPDS 86-0102) existing in the form of graphite is identified. Here, silica (JCPDS 79-1906) may exist as an impurity, and graphite and silica peaks merely affect the structural topology and may be seen in all metal-modified catalysts. For Fe/AC, new peaks appear at 2θ=29.93° and 69.39° representing the (220) and (440) planes, which may indicate Fe₃O₄ crystals, and the existence of Fe₂O₃ peaks may be confirmed through the (311) and (511) planes appearing at 2θ=35.67° and 57.29°.

The peaks of magnetite (Fe₃O₄) and hematite (Fe₂O₃) may also be identified through JCPDS 75-0033 and 84-0306, the XRD spectrum of Ni/AC may be identified through three different peaks at 2θ=44.50°, 51.86° and 76.39°, and each peak may correspond to (hkl)=(111), (200) and (220) planes indicating the cuboid structure of Ni. A mirror peak indicating NiO₂ may also be identified at 37.11°, and XRD peaks of Ni and NiO₂ may be identified through JCPDS file numbers 87-0712 and 85-1977, respectively.

Three main peaks and two minor peaks of MoO₂ may appear for Mo/AC catalyst, and the monoclinic peak of MoO₂ appears at 2θ ranging from 26° to 80° and may be identified in the literature of JCPDS file number 73-1249.

### 2. N₂ Adsorption-Desorption Measurement

FIG. 4B illustrates the N₂ adsorption-desorption isotherms of activated carbon and metal-modified activated carbon, and mechanical properties such as surface area, pore volume and average pore diameter are presented in Table 1.

TABLE 1
Textural properties of parent and metal-impregnated AC catalysts

| | | Pore | | Metal |
|---|---|---|---|---|
| | BET surface | volume^{b} | Average pore | content^{c} |
| Catalyst | area^{a} (m²/g) | (cm³/g) | diameter^{b} (nm) | (wt. %) |
| AC | 614.59 | 0.703 | 4.5752 | not |
| | | | | detected |
| Fe/AC | 593.19 | 0.3969 | 2.6762 | 10.87 |
| Ni/AC | 586.38 | 0.3964 | 2.7038 | 10.84 |
| Mo/AC | 409.59 | 0.5308 | 5.1834 | 10.81 |

^{a}Calculated by BET method
^{b}Calculated by BJH method
^{c}Calculated by ICP-OES

Comparing with the IUPAC classification, the shape of the isotherm and hysteresis loop for all catalysts may be identified as type IV and H4, respectively. According to the classification, the existence of mesopores and slit-shaped pores can be clearly confirmed. Furthermore, the similarity of isotherms between the activated carbon as a parent material and the modified and calcined activated carbon catalyst may indicate the remarkable thermal stability of catalyst.

As presented in Table 1, the surface area and pore volume of the activated carbon as a parent material may decrease through modification of each catalyst with a metal, which results from the adsorption of a smaller volume of nitrogen gas due to partial filling of the pores in Fe/AC, Ni/AC and Mo/AC, and such results may indicate that metal insertion into the pores causes decreases in surface area and pore volume. A similar phenomenon may also be observed for average pore diameters, for which reason; phenomena such as (i) metal aggregation on the mesopores and (ii) clogging of the pore inlets may be observed. However, referring to the mesopore diameter standard of 2 to 50 nm by IUPAC, it may be confirmed that the mesoporous characteristics of the catalyst are maintained despite the decrease in average pore diameter.

### 3. Inductively Coupled Plasma—Optical Emission Spectrometry

All catalysts may be produced through incipient wetness impregnation (IWI) using 10 wt. % of iron, nickel and molybdenum precursors, and ICP-OES analysis has been performed to measure the actual amount of metal oxides in the catalysts, and the analysis results are listed alongside the BET data in Table 1.

### 4. NH₃-TPD (Ammonia Temperature Programmed Desorption) Measurement

FIG. 4C illustrates ammonia desorption curves measured for activated carbon and the produced metal-modified activated carbon, and NH₃-TPD peaks may be classified into weak, moderate, and strong regions based on the acidity.

A temperature range of less than 200° C. for the weakly acidic region, a temperature range of 200° C. to 400° C. for the moderately acidic region, and a temperature range of more than 400° C. for the strong acidic region may be assigned, respectively. As a result of analyzing the height and arrangement of desorption peaks, it has been found that activated carbon as a parent material has the smallest number of regions with weak acidity and the largest number of regions with strong acidity. However, the number of regions with moderate acidity has been confirmed to be between the numbers of weak and strong regions.

It has been confirmed that the distribution tendency of acidic regions is the same for other metal-modified activated carbon catalysts. In a case where activated carbon as a parent material is modified with Fe, Ni, and Mo metals, it has been found that the desorption peaks in the low temperature range (<200° C.) and the middle temperature range (200° C. to 400° C.) shift towards the high temperature range (>400° C.). Furthermore, the width and height of peaks remarkably increase. This may indicate that the existence of metal remarkably increases the number of regions with strong acidity in all catalysts in the order of Fe/AC<Ni/AC<Mo/AC, but as presented in Table 2, it can be seen that regions with weak acidity and regions with moderate acidity are greatly limited in all catalysts including activated carbon and the activated carbon catalyst produced in the present invention.

TABLE 2
Acidity properties of parent and metal-impregnated AC catalysts

Acidic strength (mmol/g)

| Catalyst | Weak | Moderate | Strong | Acidity |
|---|---|---|---|---|
| AC | 0.027 | 0.183 | 1.845 | 2.055 |
| Fe/AC | — | 0.552 | 2.415 | 2.967 |
| Ni/AC | 0.104 | — | 3.803 | 3.907 |
| Mo/AC | 0.109 | — | 6.107 | 6.216 |

### 5. SEM (Scanning Electron Microscope) and EDS (Energy Dispersive X-Ray Spectroscopy)

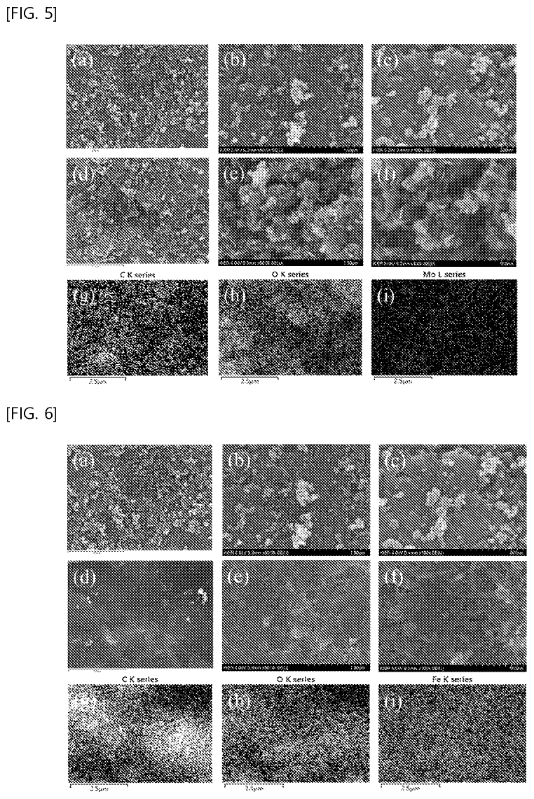

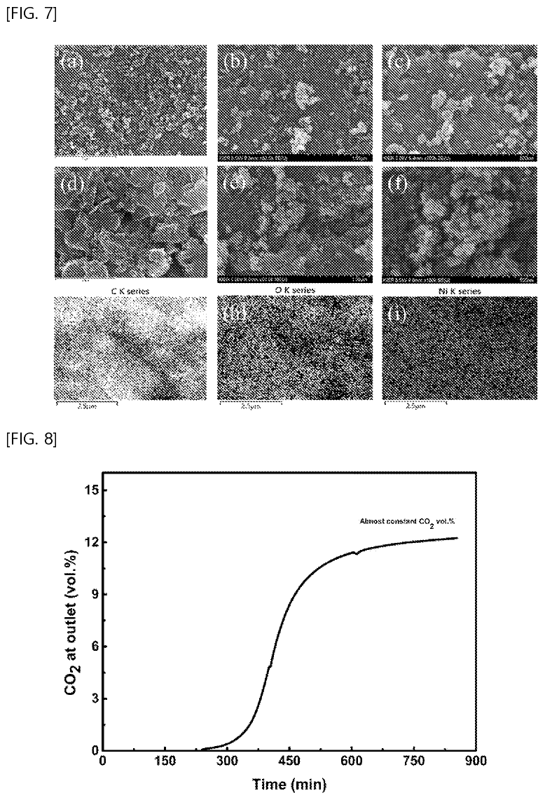

FIG. 5 illustrates scanning electron microscope (SEM) images of activated carbon and an activated carbon catalyst modified with Mo and the Mo/AC mapping results by energy dispersive X-ray spectroscopy (EDS). The SEM images and EDS mapping results of Fe/AC and Ni/AC are illustrated in FIGS. 6 and 7.

As illustrated in FIGS. 5A to 5C, the shape of activated carbon as a parent material has been measured at 22 k, 50 k, and 100 k magnifications, respectively, and through this, the amorphous structure of activated carbon can be confirmed. Confirming through FIGS. 5D to 5F, the SEM images of Mo/AC show that Mo deposition may exist as needle-shaped particles all over the surface of the activated carbon. The existence of Mo particles is not clear in the 22 k image, but may appear significantly clearly after the SEM image is magnified to 50 K to 100 k. Effective modification of activated carbon as a parent material with Mo may be confirmed through EDS mapping illustrated in FIG. 5I, and the existence of carbon and oxygen may be confirmed in FIGS. 5G and 5H. The EDS results illustrated in FIGS. 5G to 5I indicate that the Mo element is uniformly dispersed on the surface of the activated carbon, and the SEM images and EDS mapping of FIGS. 6 and 7 indicate that the elements are significantly uniformly dispersed in Fe/AC and Ni/AC as well.

### Experimental Example 2: Characteristic Evaluation

### 1. Induction of Acid Sites

In the calcination process of modifying activated carbon with a metal through incipient wetness impregnation, ammonium ions and nitrates are removed by decomposition and only the metal oxide remains on the support material. During the regeneration experiment, when a metal oxide (MO_{X}) comes into contact with water molecules, water is adsorbed on the surface of the metal oxide, MO_{X} is converted into a hydroxyl group (OH), and the hydroxyl group functions as a Bronsted acid as shown in Chemical Formulas 1 and 2 below. Hence, an unsaturated metal atom tends to receive a pair of electrons (e⁻), and this may act as a Lewis acid.

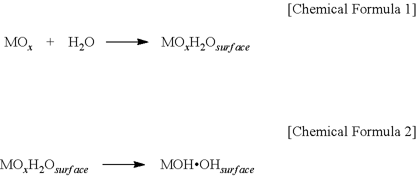

### 2. Carbon Dioxide Desorption Performance Using Catalyst

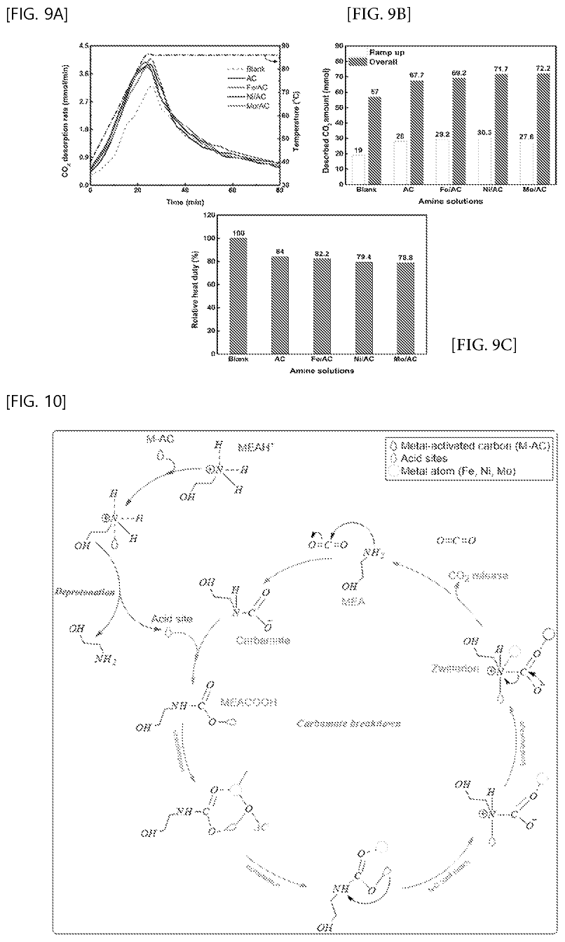

Carbon dioxide desorption rates have been measured in the case of not using a catalyst, the case of using 5 g of activated carbon, and the case of using metal-modified activated carbon, and illustrated in FIG. 9A. It can be seen that the activity of activated carbon is measured first and is further improved by the addition of metal. It may be confirmed that in the MEA solution not containing a catalyst, any noticeable change in the amount of carbon dioxide desorbed may not be observed up to 76° C., but after that, the amount of carbon dioxide desorbed increases in the solution not containing a catalyst depending only on heat. In the case of using activated carbon that is a parent material, it may be confirmed that the desorption rate is increased by approximately 19.7% at the peak value 3.97 mmol·min⁻¹ at the same temperature for the same time compared to the case of simply using only the MEA solution and having the highest carbon dioxide desorption rate at 3.32 mmol·min⁻¹.

In a case where the number of regions with acidity in activated carbon increases through the addition of metal, all metal-modified activated carbon catalysts start to desorb a significant volume of carbon dioxide from 65° C. to 70° C. depending on the existence of a large number of regions with acidity. Among all the catalysts tested, Ni/AC has been confirmed to increase the desorption rate of carbon dioxide by approximately 33%, and Mo/AC and Fe/AC may increase the desorption rate by 27.8% and 26.6%, respectively.

### 3. Total Amount of Carbon Dioxide Desorbed

Each of the catalysts produced above may have an improved effect on the overall amount of carbon dioxide desorbed compared to the basic MEA solution. Compared to only 57 mmol of carbon dioxide desorbed in the case of not using a catalyst, 67.7 mmol of carbon dioxide is desorbed and the effect is improved by 19% in the case of using activated carbon that is a parent material, and it has been confirmed that the amount of carbon dioxide desorbed is increased by 27%, 26%, and 21.7%, respectively, in the case of using Mo/AC, Ni/AC, and Fe/AC compared to that in the case of using only the MEA solution, and this may be confirmed through FIG. 9B.

### 4. Relative Heat Duty

A specific purpose of applying a catalyst in carbon dioxide desorption is to enable desorption in a lower temperature range, and the catalysts produced in the present application also have the same technical purpose. Only 33.3% of carbon dioxide is desorbed from the carbon dioxide-MEA solution not containing a catalyst at the ramp-up stage (86° C. or below) of temperature, but the amount of carbon dioxide desorbed during temperature rise greatly increases in the case of using all catalysts including activated carbon and metal-modified activated carbon.

Activated carbon as a parent material, Fe/AC and Ni/AC desorb carbon dioxide bound to the absorbent by decomposing carbamates up to 42%, but the Mo/AC catalyst increases the amount of carbon dioxide desorbed to 38.2% when the system is heated to the temperature of the ramp-up level. The reason for this improved performance may be that the catalyst receives more protons to gain access to carbamates and increase the amount of carbon dioxide desorbed, ultimately, the catalyst applied to the carbon dioxide desorption reaction may regenerate a larger amount of MEA while consuming relatively lower thermal energy compared to the carbon dioxide-MEA solution not containing a catalyst.

In an embodiment of the present application, as illustrated in FIG. 9C, Mo/AC and Ni/AC diminishes energy consumption by 21.2% and 20.6%, respectively, for MEA regeneration heat requirement compared to the MEA solution as a blank solution and may be significantly effective in diminishing energy consumption, and activated carbon as a parent material and Fe/AC catalyst diminish energy consumption by 16% and 17.8%, respectively.

5. Reaction Mechanism by which Catalyst Promotes CO₂ Absorption

As the most widely known MEA regeneration mechanism, the following Chemical Formula 3 by Michael Caplow may be used. Carbamates may be decomposed into MEA and carbon dioxide through the formation of zwitterions.

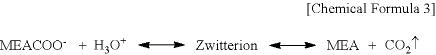

The characteristics of MEA regeneration that is carried out in a temperature range of 100° C. to 120° C. and demands a large amount of energy are due to the extreme endothermic reaction caused by the decomposition of carbamates and the hindrance of the transfer of protons from the protonated MEA (MEAH⁺) to water molecules. The transfer of protons is represented by Chemical Formula 4 below, and this limits protons in the amine regeneration system.

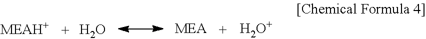

In an embodiment of the present application, supplying free protons (H⁺) to form zwitterions may be the main reason for adding a catalyst. Three points within one carbamate may be viewed as active centers, one of which is the central N atom of the carbamate and the other two are the O atoms in carbon dioxide.

In an embodiment of the present application, Lewis and Bronsted acid sites generated by addition of a metal/activated carbon catalyst attack the active points, protons required in the carbamate are satisfied by the Bronsted acid site, at which time the metal atom may attack the N— and O— atoms of the carbamate to lengthen the N—C bond. Through the bond isomerization process, the N—C bond hybridization is shifted from sp² to sp³ and the strength of the bond is weakened by lengthening the bond. Due to this phenomenon, less energy may be consumed to decompose carbamates, the mechanism is illustrated in FIG. 10, and the existence of carbonates and bicarbonates also promotes the dissociation of carbonic acid by receiving a proton shown below, resulting in carbon dioxide degassing.

### 6. Effect of Catalyst Properties on Amine Regeneration

Activated carbon and the produced metal-modified activated carbon catalysts enable rapid desorption of carbon dioxide with less heat duty, and may be regenerated in the solution by receiving spent protons from MEAH⁺. In order to examine the effect of catalyst properties on carbon dioxide desorption, the correlation between the total amount of carbon dioxide desorbed and the BET surface area, the total acid sites, and the product thereof has been measured and illustrated in FIG. 1. The physical properties of activated carbon and the produced metal-modified activated carbon catalysts are summarized in Table 3.

TABLE 3
Catalyst properties effective for promoting CO₂ desorption

| | | Acidity | BET surface |
|---|---|---|---|
| | BET surface | (TAS) | area × acidity |
| Catalyst | area (m²/g) | (mmol/g) | (mmol · m²/g²) |
| AC | 614.59 | 2.055 | 1263 |
| Fe/AC | 593.19 | 2.967 | 1760 |
| Ni/AC | 586.38 | 3.907 | 2291 |
| Mo/AC | 409.59 | 6.216 | 2546 |

Looking at the results according to FIG. 1A, the amount of carbon dioxide desorbed and the BET surface area not only have a non-linear relation but may also show a completely opposite tendency, and this is because the BET surface area has decreased after modification with a metal has been performed. As illustrated in FIG. 1B, a result may be acquired in which the amount of carbon dioxide desorbed and the total acid sites are directly proportional, and it can be seen that the total amount of carbon dioxide desorbed is strongly affected by the number of total acid sites. When the effect of BET surface area is combined with the acidity (TAS), a linear relation may be acquired, which is illustrated in FIG. 1C. It can be seen from the combined physical properties that the BET surface area alone without an acid site is not sufficient to promote the carbamate decomposition reaction.

Fe/AC has a large BET surface area but a smaller number of acid sites compared to activated carbon as a parent material and thus may not show better performance, but Mo/AC has the smallest BET surface area yet the largest number of acid sites and thus may show excellent performance. Consequently, carbon dioxide desorption may be improved through the surface area and the number of acid sites.

The foregoing description of the present invention is for illustrative purposes only, and those skilled in the art to which the present invention pertains will understand that the present invention can be easily modified into other specific forms without changing the technical spirit or essential features of the present invention. Therefore, the embodiments described above should be understood as illustrative in all respects and not limiting. For example, each component described as a single type may be implemented in a distributed manner, and similarly, components described as distributed may be implemented in a combined form.

The scope of the present invention is indicated by the following claims, and all changes or modifications derived from the meaning and scope of the claims and equivalent concepts should be interpreted as being included in the scope of the present invention.

According to an aspect of the present invention, the composite catalyst based on an activated carbon carrier modified with a metal material for regeneration of a carbon dioxide absorbent is able to regenerate MEA (monoethanolamine) at a low temperature of 100° C. or below to diminish heat consumption, and can decrease the heat duty by increasing the carbon dioxide desorption rate at a low temperature of 100° C. or below as well as acquire improved results through the relation between the BET surface area and the total acid sites.

In addition, the composite catalyst can be usefully used as a technology capable of diminishing energy demand during energy-efficient CO₂ absorbent regeneration in the field of carbon capture and storage since the metal precursors and activated carbon activated carbon of the present invention, which are materials for catalyst production, are inexpensive and abundant and final catalyst materials can be produced at an economical cost.

The effects of the present invention are not limited to the effects described above and should be understood to include all effects that can be inferred from the description of the present invention or the configuration of the invention described in the claims.

While the present invention has been described with respect to the specific embodiments, it will be apparent to those skilled in the art that various changes and modifications may be made without departing from the spirit and scope of the invention as defined in the following claims.

What is claimed is:

1. A composite catalyst for carbon dioxide absorbent regeneration comprising:
a porous carrier;
a metal material supported on a surface or inside of the porous carrier; and
an acid site that donates a proton (H⁺) to decompose a carbamate derived from an amine-based carbon dioxide absorbent,
wherein the metal material is a metal element, a metal oxide, or a combination of the metal element and the metal oxide.

2. The composite catalyst for carbon dioxide absorbent regeneration according to claim 1,
wherein the metal material is elements or oxides of one or more metals selected from a transition metal group consisting of Fe, Ni and Mo or a combination of the elements and the oxides.

3. The composite catalyst for carbon dioxide absorbent regeneration according to claim 1,
wherein a BET surface area of the composite catalyst for carbon dioxide absorbent regeneration is 400 to 600 m²/g.

4. The composite catalyst for carbon dioxide absorbent regeneration according to claim 1,
wherein a pore volume of the composite catalyst for carbon dioxide absorbent regeneration is less than 0.7 cm³/g.

5. The composite catalyst for carbon dioxide absorbent regeneration according to claim 1,
wherein a metal content in the composite catalyst for carbon dioxide absorbent regeneration is 5 to 12 wt %.

6. The composite catalyst for carbon dioxide absorbent regeneration according to claim 1,
wherein an acidity (total acid sites; TAS) of the composite catalyst for carbon dioxide absorbent regeneration is 2.5 to 6.5 mmol/g.

7. The composite catalyst for carbon dioxide absorbent regeneration according to claim 1,
wherein in a NH₃-temperature programming desorption acidity curve of the composite catalyst for carbon dioxide absorbent regeneration,
a peak intensity of a strong acid site assigned to a temperature range of more than 400° C. is larger than a peak intensity of a pure porous carrier by 1.3 to 4 times.

8. The composite catalyst for carbon dioxide absorbent regeneration according to claim 1,
wherein a carbon dioxide desorption capacity of the composite catalyst for carbon dioxide absorbent regeneration expressed by the following Formula 1 is 1500 to 3000 mmol·m²/g²:
$$( BET surface area ( {m}^{2} / g ) ) \times ( total acid sites ( mmol / g ) ) of composite catalyst \qquad [ Formula 1 ]$$

9. The composite catalyst for carbon dioxide absorbent regeneration according to claim 1,
wherein an amount of carbon dioxide desorbed by the composite catalyst for carbon dioxide absorbent regeneration is 69 to 73 mmol.

10. The composite catalyst for carbon dioxide absorbent regeneration according to claim 1,
wherein a heat duty of the composite catalyst for carbon dioxide absorbent regeneration is 77% to 83% of a heat duty in a desorption reaction not involving the catalyst.

11. The composite catalyst for carbon dioxide absorbent regeneration according to claim 1,
wherein the porous carrier is activated carbon.

12. A method for producing a composite catalyst for carbon dioxide absorbent regeneration, the method comprising:
dissolving a precursor of a metal material in a solvent to prepare a mixture;
injecting the mixture into a surface or inside of a porous carrier to prepare a support solution;
drying the support solution; and
performing calcination to obtain a composite catalyst,
wherein the composite catalyst contains an acid site that donates a proton (H⁺) to decompose a carbamate derived from an amine-based carbon dioxide absorbent, and
the metal material is a metal element, a metal oxide, or a combination of the metal element and the metal oxide.

13. The method for producing a composite catalyst for carbon dioxide absorbent regeneration according to claim 12,
wherein in the step of dissolving a precursor of a metal material in a solvent to prepare a mixture,
a mass percentage of the metal material precursor is 8 to 12 wt % based on a total weight of the mixture.

14. The method for producing a composite catalyst for carbon dioxide absorbent regeneration according to claim 12,
wherein the step of drying the support solution is performed at a temperature of 80° C. to 120° C. for 5 to 7 hours.

15. The method for producing a composite catalyst for carbon dioxide absorbent regeneration according to claim 12,
wherein the step of performing calcination to obtain a composite catalyst is performed in a temperature range of 450° C. to 550° C. for 5 to 7 hours.
